(19) United States
(12) Patent Application Publication
(10) Pub. No.: US 2004/0104305 A1
(43) Pub. Date: Jun. 3, 2004

(54) AIRCRAFT WHEEL SPIN-UP ROTOR

(76) Inventor: Sean P. Stapf, White Plains, MD (US)

Correspondence Address: Sean Stapf, 4189 Windsor Heights Place, White Plains, MD, 20695, US

(21) Appl. No.: 10/604,724

(22) Filed: Aug. 13, 2003

(51) Int. Cl. B64C 25/32

(52) U.S. Cl. 244/103 S

(57) ABSTRACT

It is, therefore, an object of the present invention to create an aircraft wheel “Spin-Up” (pre-spin) on approach to landing so that it reduces wear on aircraft tire tread, as well as reduces shear stress on the tire body, thus increasing safety and the life span of the tire while reducing the life cycle cost of the aircraft. It is another object of the present invention to provide this wheel spin-up by use of the existing airflow, without the need for electronics, hydraulics, pneumatics, or other additional hardware beyond the near-non-moving parts of the Aircraft Wheel Spin-Up Rotor. It is yet another object of the present invention to provide this aircraft wheel spin-up in a way that is easily retrofit to existing aircraft without a significant addition of hardware or disruption in operating and maintenance procedures. It is a further object of the present invention to provide this wheel spin-up in a way that reduces the touchdown stresses, fatigue, and safety problems related to the sliding frictional impulse caused by the disparity between the wheel speed and the runway speed, not the least of which are skidding during emergency and adverse landings such as on ice, snow, rocky terrain, and rain-wet runways.

### BACKGROUND OF INVENTION

When an aircraft approaches the runway for landing, the wheels are not spinning, while the aircraft is typically traveling above the landing surface at between 120 and 250 miles per hour. Therefore, when the aircraft's tires first touch down, the tires skid on the landing surface. The frictional force applied to the tires during this skidding period—required to produce the angular acceleration to “spin up” the aircraft wheels to a rate consistent with the aircraft velocity—is estimated to apply a transient acceleration pulse to the aircraft of nominally up to 0.5 g for 0.5 seconds. The resulting wear of the tire tread, along with the transient force applied to the rest of the tire and landing gear, is a degrading element to the aircraft's safety, comfort, and life cycle cost.

### SUMMARY OF INVENTION

The Aircraft Wheel Spin-Up Rotor is a method for harnessing ambient airflow to induce a “pre-spin” to the aircraft wheel, prior to touchdown. An example of the method is a hub that bolts against the wheel of the tires of aircraft landing gear. The hub has biased aerodynamic contours similar to the cups on anemometers that, in airflow, produce a forward-rotational torque on each wheel of the landing gear. On approach to landing, when the landing gear is deployed and exposed to the air stream, the aerodynamic torque from the rotor gradually brings the wheels up to a customized, more-survivable spin rate in preparation for touchdown on the landing surface. A second method of harnessing ambient airflow to induce a “pre-spin” to the aircraft wheel is by the attachment of a static, aerodynamic “cup” to the nearby hardware of the landing gear, which diverts airflow against the wheel causing a beneficial rotation.

### BRIEF DESCRIPTION OF DRAWINGS

FIG. 1: EXAMPLE OF ONE METHOD FOR INCORPORATING THE AERODYNAMIC EFFECTS NEEDED FOR WHEEL SPIN-UP. This diagram illustrates a notional method for creating a customized aerodynamic torque on the wheel by installing a contoured hub between the existing wheel and the existing lug nuts.

FIG. 2: EXAMPLE OF PREDICTED WHEEL ROTATIONAL RESPONSE AS A FUNCTION OF WHEEL SIZE, ROTOR AERODYNAMICS, AXLE FRICTION, ETC. This diagram illustrates the results of an example of a predicted performance for a typical configuration. The inputs for the analysis of standard rotational torque and moment of inertia dynamics were the wheel size, aircraft airspeed, hub (Spin-Up Rotor) dimensions and related aerodynamics, landing gear deployment time, etc.

FIG. 3: EXAMPLE OF STATIC “CUP” METHOD FOR INCORPORATING THE AERODYNAMIC EFFECTS NEEDED FOR WHEEL SPIN-UP. This diagram illustrates a method for creating an aerodynamically-induced wheel rotation by the attachment of an aerodynamic surface (a “cup”; a contour, baffle, or similar blade) to the non-moving (non-rotating) parts of the aircraft landing gear near the wheel. This cup diverts the ambient airflow during flight toward the wheel to produce a beneficial wheel rotation prior to touchdown.

### DETAILED DESCRIPTION

The Aircraft Wheel Spin-Up Rotor is a method for harnessing ambient airflow to induce a “pre-spin” to the aircraft wheel, prior to touchdown. An example of the method is a hub that bolts against the wheel of the tires of aircraft landing gear. The hub has biased aerodynamic contours—similar to the cups on anemometers—that, in airflow, produce a forward-rotational torque on each wheel of the landing gear. On approach to landing, when the landing gear is deployed and exposed to the air stream, the aerodynamic torque from the rotor gradually brings the wheels up to a customized, more-survivable spin rate in preparation for touchdown on the landing surface. A second method of harnessing ambient airflow to induce a “pre-spin” to the aircraft wheel is by the attachment of a static, aerodynamic “cup” to the nearby hardware of the landing gear, which diverts airflow against the wheel causing a beneficial rotation.

### BEST MODE FOR CARRYING OUT THE INVENTION

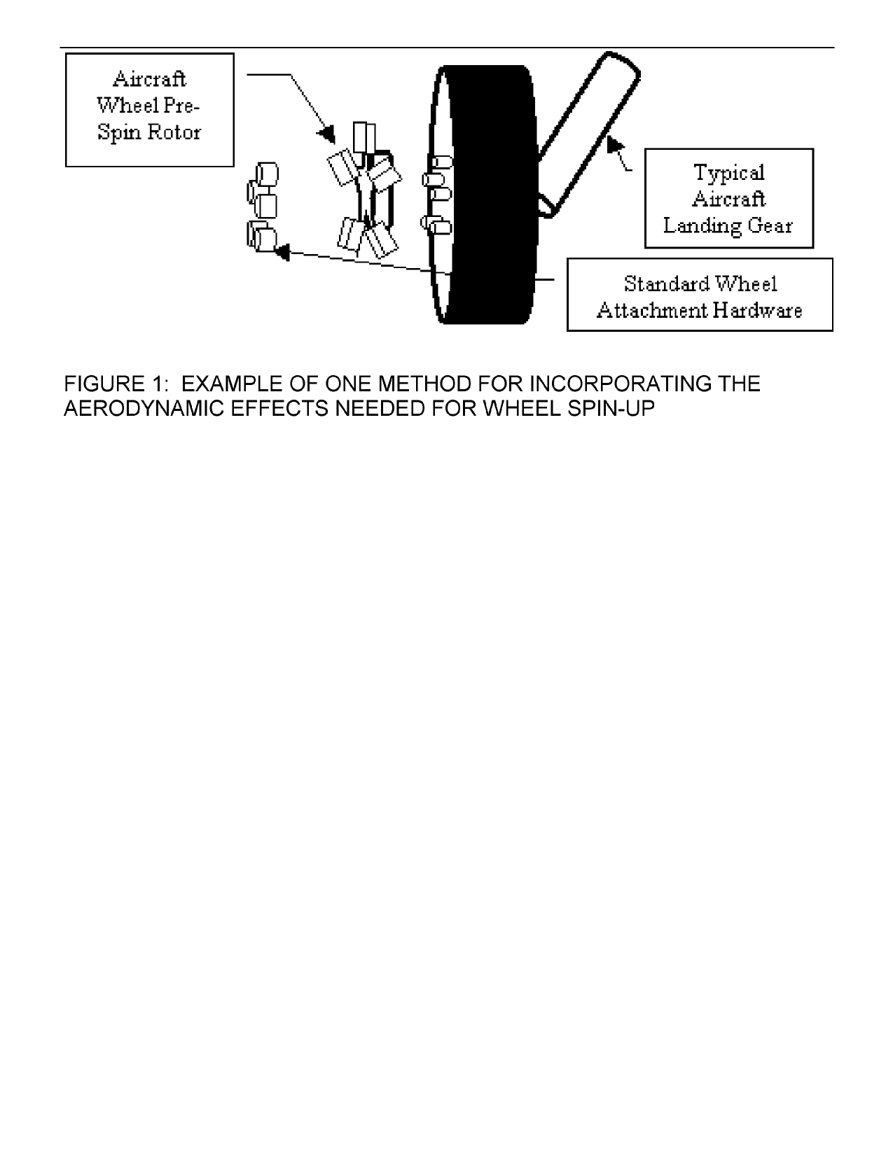

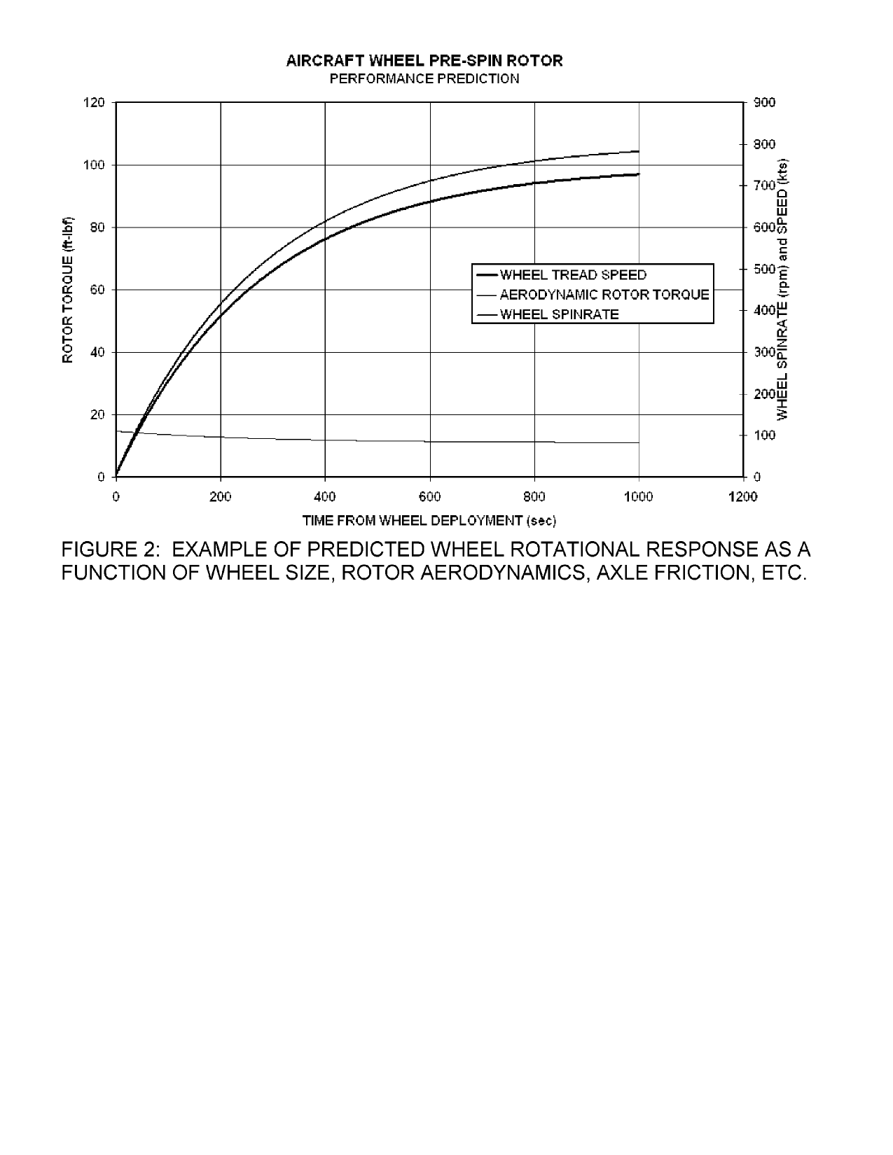

Referring now more particularly to the artwork of FIGS. 1 and 4, a depiction of the best mode for carrying out this invention is presented. The Aircraft Wheel Spin-Up Rotor in the form of an aerodynamic, lightweight, polymer “hub” is believed to be the most ideal implementation of this invention. This hub—while being custom designed to fit over each aircraft's existing landing gear lugs (by being bored to the lug pattern of the wheel) and the wheels existing contours (by being formed to match the wheel concavity without disruption within the wheel well)—can be aerodynamically custom designed to provide the wheel with an optimum torque profile (as depicted in FIG. 2) for the preferred aircraft approach speed, nominal wheel rotation friction, tire moment of inertia, diameter, etc. In this manner—a mass-production “stamping” of these hubs can be developed for a particular model of aircraft, such that retrofit and replacement costs are negligible, and allows incorporation into existing routine maintenance operations without disruption. Plastic materials offer the most likely initial benefits of durability, lightweight, low cost, flexibility, ease of replacement, etc., however some lightweight metals can offer similar performance. Subsequent improvements to these hubs are then possible, due to improvements in materials (such as metal alloys, lightweight composite resins, plastics of varying flexibilities, or the use of highly-flexible materials such as Kevlar which can be made into near-fabric “flaps” that can open and close the aerodynamic “anemometer” faces based on airspeed and centripetal acceleration caused by wheel rotation) and due to improvements in the aerodynamic contours that are possible with better understandings of the airflow conditions into and around the wheel hub area.

Alternate attachment methods may also be considered, such as welding, press-fits, adhesives, clamps, etc. All manner of aerodynamic torque-producing contours are conceivable, such as cups, blades, flaps, etc. It is also possible to build the rotor hub properties (aerodynamic rotational bias) into the wheel or tire itself, if new design is preferred over retrofit. Further, if there is a concern about over-spinning the wheel in cases of inadvertent gear deployment at undesirably high speeds, then the blades of the rotor can be made flexible to provide an attenuated torque at high air speeds. If there is concern about under-spinning the wheel, the spin rate can be increased by aerodynamic surface increases until the tread surface of the tire actually exceeds the air speed of the aircraft, because of the small-than-tire diameter of the hub.

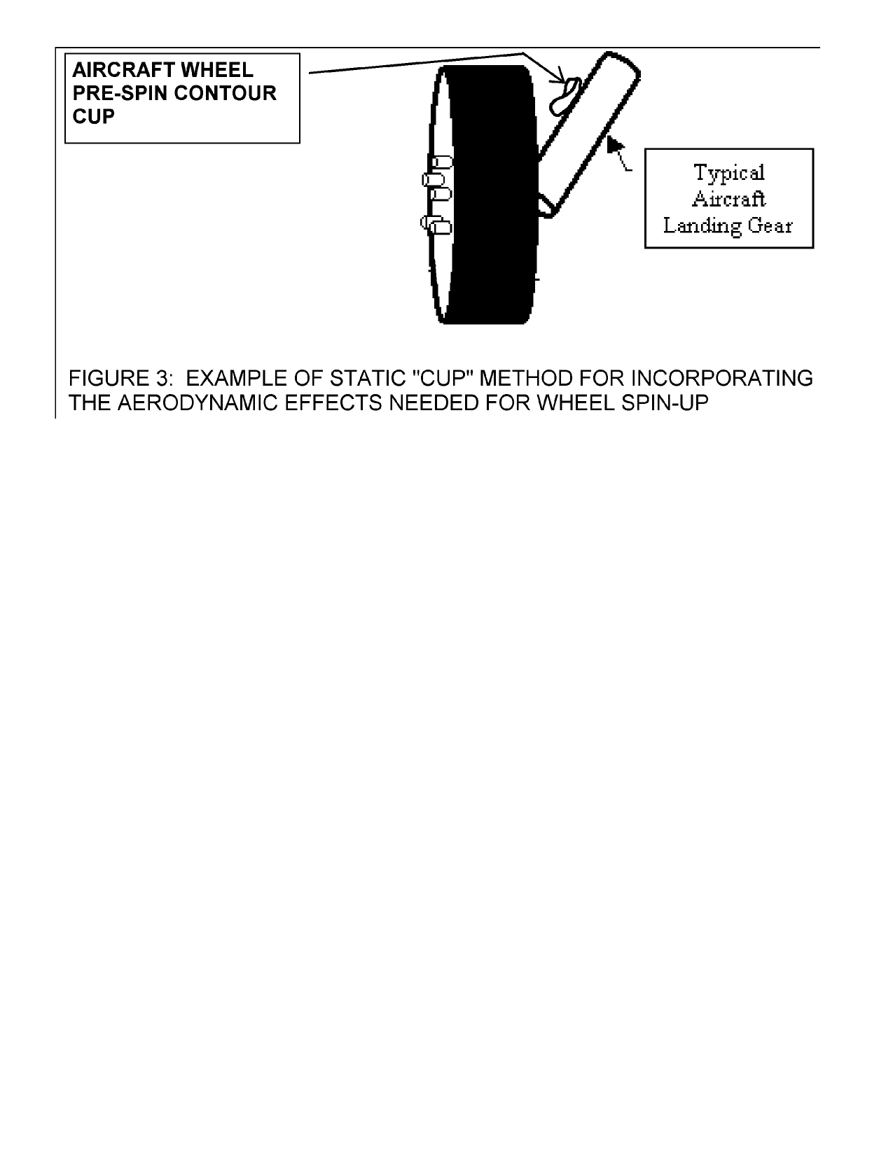

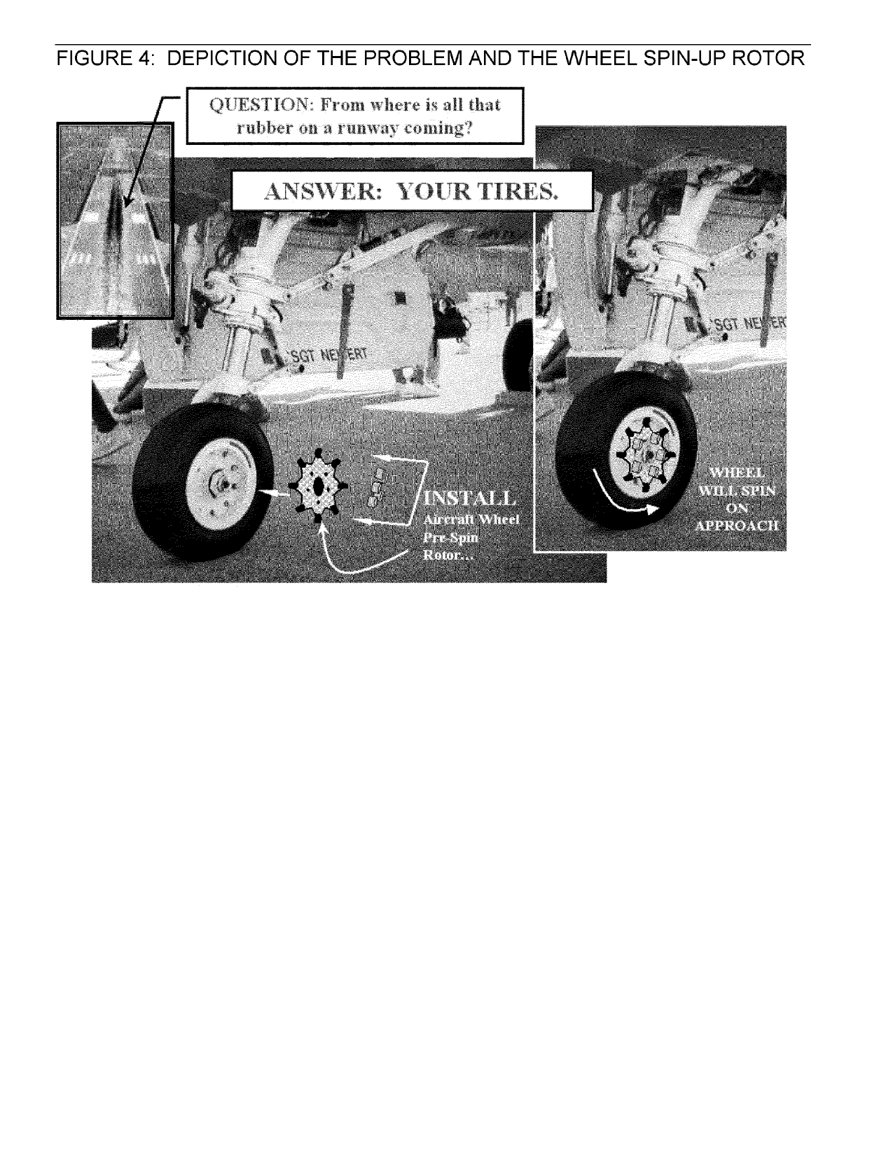

Referring now more particularly to the artwork of FIG. 3 a depiction of an alternate mode of producing wheel rotation by harnessing of ambient airflow is presented. The alteration of existing hardware, or the attachment of a particularly and deliberately-designed aerodynamic surface (a “cup”; a contour, baffle, or similar blade) to the non-moving (non-rotating) parts of the aircraft landing gear near the wheel can divert the ambient airflow to put a rotational bias on the wheel during exposure to air. This “cup” can be aerodynamically custom designed to provide the wheel with an optimum torque profile (as depicted in FIG. 2), as for the “hub”. However, this alternative mode (“cup”) is anticipated to be less ideal, as the wheel—fairly aerodynamic without the aerodynamic contours provided by the rotor “hub”—is not expected to receive a reliable torque from the diverter. The “cup” also has the likelihood of producing unnecessary wind noise, drag and lift forces, and can become “Foreign Object Debris” (“FOD”) without the benefit of being retrofit beneath the wheel lugs (as is possible with the “hub”).

### EXAMPLES OF ANTICIPATED BENEFITS OF THE INVENTION

In either manufacturing scenario described, the anticipated—and analytically predicted—benefits of this aircraft wheel pre-spin are as follow:

1) Reduces wear on aircraft tire tread, as well as reduces shear stress on the tire body, thus increasing safety and the life span of the tire while reducing the life cycle cost of the aircraft.

2) Reduces touchdown stresses on aircraft tires during emergency landings (such as landing on unpaved surfaces, or clipping the approach edge of an aircraft carrier deck), where tire trauma from skidding against obstacles can cause premature tire failure and loss of control if the wheel is not rolling.

3) Improves the aircraft tire's grip on normal landing surfaces by increasing the tendency toward ‘static’ friction, rather than the tires skidding in ‘kinetic’ friction. This improved tire grip increases the safety and maneuverability of the aircraft during landing especially during friction-compromised landing surface conditions such as snow, ice, and rain.

4) Reduces wear and debris on the landing surface by reducing the shear stress and rubber accretion from skidding aircraft tires during landing.

5) Provides a secondary (redundant) indicator of airspeed for aircraft instrumented with wheel (ground) speed indicators.

6) Reduces stress on aircraft and its landing gear by reducing the touchdown shear force (which becomes an aft load on the aircraft and a bending moment on its landing gear) required to overcome the wheel's rotational inertia and spin it up to speed.

7) Reduces touchdown discomfort (and resulting stress and fatigue) on crew and passengers by reducing the longitudinal deceleration pulse at aircraft touchdown.

8) Verifies free rotation of wheels in mid-air, thus verifying a degree of wheel deployment along with proper wheel axle freedom for aircraft without deployment indicators (or as a redundant indicator for aircraft with these monitors).

9) Operates passively, as there is no need of additional electronics, hydraulics, pneumatics, or other extended hardware beyond the aerodynamic contour.

10) Can be immediately retrofitted to nearly any aircraft, with installation likely only requiring the existing wheel lug nuts to be removed and reinstalled.

11) Automatically adjusts to a change in approach speed by having airflow-based torque.

12) Performs as a non-critical item to the aircraft, such that if failure occurs it will not interfere with the immediate performance of the aircraft.

Although the present invention has been shown and described with respect to certain examples and preferred embodiments, changes which would be obvious to a person ordinarily skilled in the art to which the invention pertains are deemed to lie within the spirit and scope of the invention.

1. A contour to the landing gear of an aircraft such that ambient airflow causes rotation of the wheel.

2. A contour as claimed in claim 1 wherein the rotational bias from the airflow is caused by the installation of a Spin-Up Rotor (a “hub”) onto the wheel.

3. A hub as claimed in claim 2 wherein the attached hardware is contoured for aerodynamic performance such as an anemometer, fitted with mating surfaces and/or holes such as to match the existing wheel mounting hardware, and thus clamped between the original wheel and lug nuts for a retrofit installation that requires no additional hardware, no additional moving parts, and no significant changes to operational procedures.

4. A contour as claimed in claim 1 wherein the rotational bias from the ambient airflow is caused by diversion of the airflow against the wheel by use of a diverter (a “cup”; a contoured “baffle”, blade, or similar engagement to the air stream) which is mounted onto the non-moving (non-rotating) portions of the landing gear near the wheel, and operates passively (requiring no moving parts, electricity, hydraulics, etc.).

5. A contour as claimed in claim 1 wherein the rotational bias from the ambient airflow is caused by aerodynamic surfaces intrinsically built into (i.e. without retrofit—originally incorporated into the landing gear component during manufacture) the wheel, tire tread, suspension, or similar region of the aircraft.
